(19) United States
(12) Patent Application Publication
(10) Pub. No.: US 2018/0248458 A1
(43) Pub. Date: Aug. 30, 2018

(54) VIBRATING MOTOR

(71) Applicant: Nidec Seimitsu Corporation, Ueda-shi (JP)

(72) Inventor: Syunsuke AMEMIYA, Ueda-shi (JP)

(21) Appl. No.: 15/879,471

(22) Filed: Jan. 25, 2018

(30) Foreign Application Priority Data
Feb. 28, 2017 (JP) 2017-036118

(51) Int. Cl. H02K 33/12; H02K 33/02; H02K 55/04; H02K 1/34

(52) U.S. Cl. CPC H02K 33/12; H02K 1/34; H02K 55/04; H02K 33/02

(57) ABSTRACT

A vibrating motor includes a shaft, a stationary portion, a vibrating body, a first coil spring, a second coil spring, a first support plate, and a second support plate. The shaft has a central axis extending in one direction. The shaft includes a coil wound around the central axis. The vibrating body is disposed radially outside the shaft and radially inside the coil and is capable of vibrating in one direction with respect to the stationary portion. The first and second coil springs are each disposed between the stationary portion and the vibrating body and wound in the circumferential direction. The first and second support plates are each disposed between the vibrating body and each coil spring. The vibrating body includes two magnets. The first and second support plates include a magnetic substance and are always pressed against one of the magnets.

### CROSS REFERENCE TO RELATED APPLICATIONS

This application claims the benefit of priority to Japanese Patent Application No. 2017-036118 filed on Feb. 28, 2017. The entire contents of this application are hereby incorporated herein by reference.

### BACKGROUND OF THE INVENTION

### 1. Field of the Invention

The present disclosure relates to a vibrating motor.

### 2. Description of the Related Art

Various devices, such as smartphones, generally include a vibrating motor. Japanese Patent No. 5342516 discloses the following conventional vibration actuator.

The vibration actuator disclosed in Japanese Patent No. 5342516 includes a cylindrical casing. The casing houses a coil, a magnet, and first and second weights. The coil is wound in a circular form around the vibration axis of the casing. The magnet is cylindrical in shape and encloses the coil. The first and second weights are disposed next to both sides of the magnet in the direction of the vibration axis. Pole pieces are respectively disposed between the first and second weights and the magnet. The magnet, the pole pieces, and the first and second weights constitute a mover. A shaft passes through the mover. Both ends of the shaft are fixed to the end walls of the casing.

The first weight and the second weight each have a spring receiving hole. A first coil spring inserted in the spring receiving hole is disposed between the first weight and an end wall of the casing. Likewise, a second coil spring inserted in the spring receiving hole is disposed between the second weight and an end wall of the casing. The shaft passes through the first coil spring and the second coil spring.

This configuration allows the mover to vibrate linearly in the direction of the vibration axis with cooperation of the coil and the magnet.

However, in the vibration actuator disclosed in Japanese Patent No. 5342516, the pole pieces made of a magnetic material are fixed to the magnet by a magnetic force, but the first and second weights are fixed to the pole pieces only by the pressure of the elastic force of the coil springs. For that reason, the fixation of the first and second weights is unstable, causing the configuration of a laterally vibrating portion to be unstable. The configuration disclosed in Japanese Patent No. 5342516 includes two weights, so that the configuration of the vibrating motor is not simple.

### SUMMARY OF THE INVENTION

In an embodiment of the present disclosure, a vibrating motor includes a shaft, a stationary portion, a vibrating body, a first coil spring, a second coil spring, a first support plate, and a second support plate. The shaft has a central axis extending in one direction. The shaft includes a coil wound in a circumferential direction of the central axis. The vibrating body is disposed radially outside the shaft and radially inside the coil and is configured to be capable of vibrating in one direction with respect to the stationary portion. The first coil spring is disposed on a first side in one direction between the stationary portion and the vibrating body and wound in the circumferential direction. The second coil spring is disposed on a second side in one direction between the stationary portion and the vibrating body and wound in the circumferential direction. The first support plate is disposed between the first side of the vibrating body in one direction and the first coil spring. The second support plate is disposed on the second side of the vibrating body in one direction and the second coil spring. The vibrating body includes a first magnet disposed on the first side in one direction and a second magnet disposed on the second side in one direction. The first support plate includes a magnetic substance and is always pressed against the first magnet by an elastic force of the first coil spring. The second support plate includes a magnetic substance and is always pressed against the second magnet by an elastic force of the second coil spring.

According to an embodiment of the present disclosure, a simple vibrating motor with a stable vibrating portion can be easy assembled.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall perspective view of a vibrating motor according to an embodiment of the present disclosure illustrating the appearance thereof.

FIG. 2 is an exploded perspective view of the vibrating motor according to the embodiment of the present disclosure.

FIG. 3 is a side sectional view of the vibrating motor according to the embodiment of the present disclosure.

### DETAILED DESCRIPTION OF THE PREFERRED EMBODIMENTS

Embodiments of the present disclosure will be described hereinbelow with reference to the drawings.

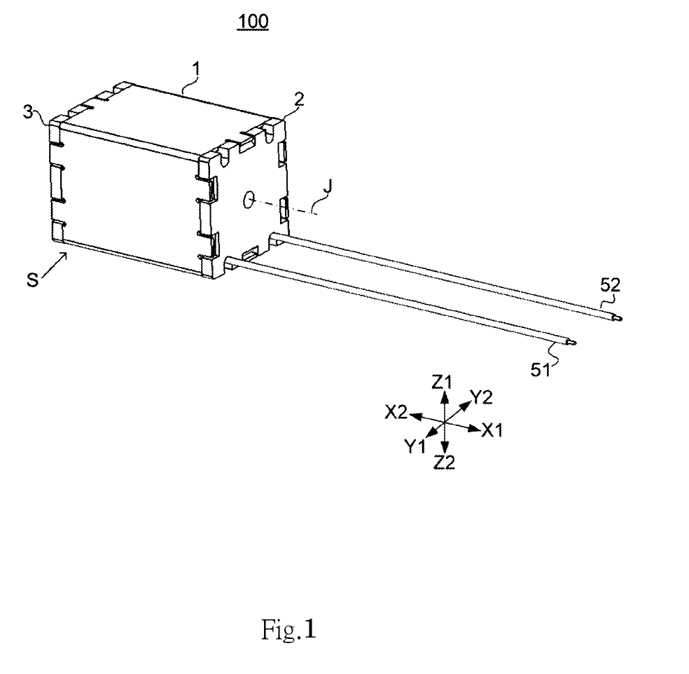

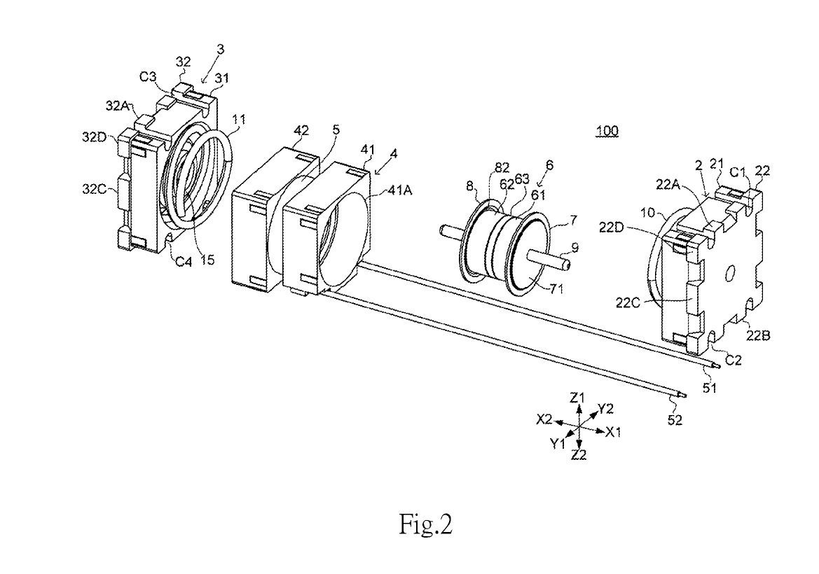

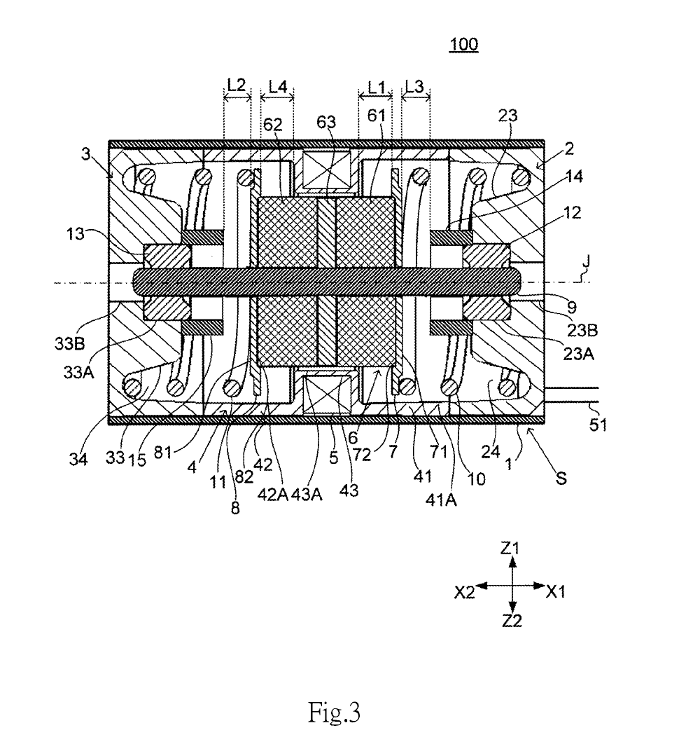

FIG. 1 is an overall perspective view of a vibrating motor 100 according to an embodiment of the present disclosure illustrating the appearance thereof. FIG. 2 is an exploded perspective view of the vibrating motor 100. FIG. 3 is a side sectional view of the vibrating motor 100. FIG. 3 illustrates the vibrating motor 100 in a non-operational state in which a vibrating body 6 is in a stationary state.

Hereinafter, a direction in which the central axis J of a shaft 9 extends is referred to as “one direction” and is expressed as “X-direction” in the drawings. Specifically, “one side in one direction” is represented by X1, and “the other side in one direction” is represented by X2.

A direction orthogonal to one direction is referred to as “lateral direction” and is expressed as “Y-direction”. Specifically, “left side” is represented by Y1, and “right side” is represented by Y2. A direction orthogonal to one direction and the lateral direction is referred to as “vertical direction” and is expressed as Z-direction in the drawings. Specifically, “upper side” is represented by Z1, and “lower side” is represented by Z2.

A radial direction around the central axis J is simply referred to as “radial direction”, and a circumferential direction around the central axis J is simply referred to as “circumferential direction”. However, the above directions do not indicate the directions of actual incorporation to the product.

The vibrating motor 100 according to an embodiment of the present disclosure roughly includes a stationary portion S, a vibrating body 6, a first support plate 7, a second support plate 8, a shaft 9, a first coil spring 10, and a second coil spring 11.

The stationary portion S includes a casing 1, a first cover 2, a second cover 3, a coil fixing portion 4, a coil 5, a first bearing 12, a second bearing 13, a first damper member 14, and a second damper member 15.

The casing 1 is a rectangular cover member extending in one direction and includes an upper surface, a lower surface, and right and left sides. The casing 1 opens on both sides in one direction.

The first cover 2 (end cover) includes a base portion 21 and an outer wall 22. The base portion 21 and the outer wall 22 are configured as one member. The outer wall 22 is disposed on one side of the base portion 21 in one direction. The outer wall 22 has a 180-degree rotationally symmetric shape as viewed from one side in one direction.

The outer wall 22 includes two protruding portions 22A disposed in the lateral direction on the upper side. The protruding portions 22A protrude upward from the base portion 21 as viewed from the other side in one direction. The outer wall 22 includes two protruding portions 22B disposed in the lateral direction on the lower side. The protruding portions 22B protrude downward from the base portion 21 as viewed from the other side in one direction. The outer wall 22 includes protruding portions 22C disposed on the right and left sides. The protruding portions 22C protrude rightward and leftward from the base portion 21 as viewed from the other side in one direction. The outer wall 22 includes protruding portions 22D disposed at four corners. The protruding portions 22D protrude in the vertical direction and the lateral direction from the base portion 21 as viewed from the other side in one direction.

A cutout portion C1 is provided between each protruding portion 22A and each protruding portion 22D of the outer wall 22. In other words, two cutout portions C1 are disposed in the lateral direction. A cutout portion C2 is provided between each protruding portion 22B and each protruding portion 22D of the outer wall 22. In other words, two cutout portions C2 are disposed in the lateral direction. The cutout portions C1 and C2 extend in one direction across the outer wall 22 and the base portion 21.

The first cover 2 is attached to the casing 1 by inserting the base portion 21 through an opening of the casing 1 on one side in one direction and bringing one end of the casing 1 in one direction into contact with the protruding portions 22A to 22D.

The second cover 3 (end cover) has the same shape as the shape of the first cover 2 and includes a base portion 31 and an outer wall 32. The base portion 31 and the outer wall 32 are configured as one member. The outer wall 32 is disposed on the other side of the base portion 31 in one direction. The outer wall 32 has a 180-degree rotationally symmetric shape as viewed from the other side in one direction.

The outer wall 32 includes two protruding portions 32A disposed in the lateral direction on the upper side. The protruding portions 32A protrude upward from the base portion 31 as viewed from one side in one direction. The outer wall 32 includes two protruding portions 32B (not illustrated) disposed in the lateral direction on the lower side. The protruding portions 32B protrude downward from the base portion 31 as viewed from one side in one direction. The outer wall 32 includes protruding portions 32C disposed on the right and left sides. The protruding portions 32C protrude rightward and leftward from the base portion 31 as viewed from one side in one direction. The outer wall 32 includes protruding portions 32D disposed at four corners. The protruding portions 32D protrude in the vertical direction and the lateral direction from the base portion 31 as viewed from one side in one direction.

A cutout portion C3 is provided between each protruding portion 32A and each protruding portion 32D of the outer wall 32. In other words, two cutout portions C3 are disposed in the lateral direction. A cutout portion C4 is provided between each protruding portion 32B and each protruding portion 32D of the outer wall 32. In other words, two cutout portions C4 are disposed in the lateral direction. The cutout portions C3 and C4 extend in one direction across the outer wall 32 and the base portion 31.

The second cover 3 is attached to the casing 1 by inserting the base portion 31 through an opening of the casing 1 on the other side in one direction and bringing the other end of the casing 1 in one direction into contact with the protruding portions 32A to 32D.

The first cover 2 includes therein a bearing holding portion 23 protruding to the other side in one direction. A ring-shaped groove 24 is provided around the outer circumference of the bearing holding portion 23. The bearing holding portion 23 includes a bearing fixing hole 23A and a through-hole 23B. The bearing fixing hole 23A is disposed on the other side in one direction with respect to the through-hole 23B and is connected to the through-hole 23B. The through-hole 23B is smaller in diameter than the bearing fixing hole 23A. The first bearing 12 is fixed to the bearing fixing hole 23A. The first bearing 12 is a sleeve bearing or the like.

The second cover 3 includes therein a bearing holding portion 33 protruding to one side in one direction. A ring-shaped groove 34 is provided around the outer circumference of the bearing holding portion 33. The bearing holding portion 33 includes a bearing fixing hole 33A and a through-hole 33B. The bearing fixing hole 33A is disposed on one side in one direction with respect to the through-hole 33B and is connected to the through-hole 33B. The through-hole 33B is smaller in diameter than the bearing fixing hole 33A. The second bearing 13 is fixed to the bearing fixing hole 33A. The second bearing 13 is a sleeve bearing or the like.

The coil fixing portion 4 (coil bobbin) includes a first base portion 41, a second base portion 42, and a cylindrical portion 43. The first base portion 41, the second base portion 42, and the cylindrical portion 43 are configured as one member. The first base portion 41 is disposed on one side in one direction with respect to the second base portion 42 and faces the second base portion 42 in one direction. The cylindrical portion 43 is sandwiched from both sides in one direction between the first base portion 41 and the second base portion 42.

The first base portion 41 includes a hole 41A which opens on one side in one direction and which extends in one direction. The second base portion 42 includes a hole 42A which opens on the other side in one direction and which extends in one direction. The cylindrical portion 43 includes a through-hole 43A, radially inside, which passes therethrough in one direction. The through-hole 43A communicates with the hole 41A and the hole 42A.

The coil 5 is wound in the circumferential direction radially outside the cylindrical portion 43 and is fixed by the coil fixing portion 4. The coil 5 is sandwiched between the first base portion 41 and the second base portion 42. Of the coil fixing portion 4, a portion up to a position in contact with one end face of the coil 5 in one direction corresponds to the first base portion 41, and a portion up to a position in contact with the other end face of the coil 5 in one direction corresponds to the second base portion 42. Lead wires 51 and 52 drawn out from the coil 5 are passed below the first base portion 41 and extend to one side in one direction. The lead wires 51 and 52 are passed through the cutout portions C2 of the outer wall 22 of the first cover 2 and are drawn out of the stationary portion S.

The vibrating body 6 includes a first magnet 61, a second magnet 62, and a pole piece 63. The first magnet 61, the second magnet 62, and the pole piece 63 are cylindrical in shape and each include a through-hole in one direction. The first magnet 61 is disposed on one side of the second magnet 62 in one direction. The pole piece 63 is sandwiched from both side in one direction between the first magnet 61 and the second magnet 62.

The shaft 9 is a rod-like member extending in one direction. The shaft 9 passes through the through-holes of the first magnet 61, the second magnet 62, and the pole piece 63, so that the first magnet 61, the second magnet 62, and the pole piece 63 are fixed to the shaft 9. In other words, the vibrating body 6 is disposed radially outside the shaft 9. The vibrating body 6 is fixed to the shaft 9 by adhesion with an adhesive or the like. The end of the shaft 9 on one side in one direction is held by the first bearing 12, and the other end in one direction is held by the second bearing 13. This allows the vibrating body 6 and the shaft 9 to be supported so as to be movable in one direction.

The vibrating body 6 is disposed in the hole 42A, the through-hole 43A, and the hole 41A. In other words, the vibrating body 6 is disposed radially inside the coil 5. The first magnet 61, the second magnet 62, and the pole piece 63 can form a magnetic path for a magnetic flux generated on the coil 5.

The first coil spring 10 and the second coil spring 11 are wound in the circumferential direction. The end of the first coil spring 10 on one side in one direction is housed in the groove 24 of the first cover 2. The other end of the second coil spring 11 in one direction is housed in the groove 34 of the second cover 3. The first coil spring 10 is wound toward the other side in one direction as it rotates rightward in the circumferential direction as viewed from one side in one direction. The second coil spring is wound toward one side in one direction as it rotates rightward in the circumferential direction as viewed from the other side in one direction. The first coil spring 10 and the second coil spring 11 overlap with the coil 5 in one direction. The first bearing 12 is disposed radially inside the first coil spring 10. The second bearing 13 is disposed radially inside the second coil spring 11.

The first support plate 7 and the second support plate 8 have the same disc-like shape. The first support plate 7 is disposed between the end of the first coil spring 10 on the other side in one direction and the first magnet 61. The second support plate 8 is disposed between the end of the second coil spring 11 on one side in one direction and the second magnet 62.

The first support plate 7 includes a protruding portion 71 protruding to one side in one direction and a recessed portion 72 recessed to one side in one direction. The protruding portion is disposed radially inside the first coil spring 10. The recessed portion 72 houses the end of the first magnet 61 on one side in one direction.

The first support plate 7 includes a magnetic substance. The whole of the first support plate 7 may be made of a magnetic substance, or only the recessed portion 72 may be made of a magnetic substance. This allows the first support plate 7 to be attracted to the first magnet 61 by magnetic force.

The second support plate 8 includes a protruding portion 81 protruding to the other side in one direction and a recessed portion 82 recessed to the other side in one direction. The protruding portion 81 is disposed radially inside the second coil spring 11. The recessed portion 82 houses the other end of the second magnet 62 in one direction.

The second support plate 8 includes a magnetic substance. The whole of the second support plate 8 may be made of a magnetic substance, or only the recessed portion 82 may be made of a magnetic substance. This allows the second support plate 8 to be attracted to the second magnet 62 by magnetic force.

The first support plate 7 is always pressed against the first magnet 61 by being pressed by the elastic force of the first coil spring 10. The second support plate 8 is always pressed against the second magnet 62 by being pressed by the elastic force of the second coil spring 11. As described above, the first support plate 7 is attracted to the first magnet 61 by the magnetic force and is always pressed against the first magnet 61 by the first coil spring 10, so that the first support plate 7 can be firmly fixed to the first magnet 61. Likewise, the second support plate 8 is attracted to the second magnet 62 by the magnetic force and is always pressed against the second magnet 62 by the second coil spring 11, so that the second support plate 8 can be firmly fixed to the second magnet 62.

The first damper member 14 is cylindrical in shape and is fixed to the top of the bearing holding portion 23 of the first cover 2. The first damper member 14 is opposed to the first support plate 7 in one direction. The second damper member 15 is cylindrical in shape and is fixed to the top of the bearing holding portion 33 of the second cover 3. The second damper member 15 is opposed to the second support plate 8 in one direction.

In the vibrating motor 100 with the above configuration, when the coil 5 is not energized from the lead wires 51 and 52, no force is applied to the vibrating body 6, so that the vibrating body 6 is in a stationary state. When the coil 5 is energized in the stationary state, a force is applied to the vibrating body 6 by the interaction between the magnetic flux generated in the coil 5 and the magnetic flux generated in the vibrating body 6, so that the vibrating body 6 vibrates in one direction. At that time, the shaft 9 also vibrates in one direction, with both ends supported by the first bearing 12 and the second bearing 13. The first support plate 7 and the second support plate 8 also vibrate in one direction at that time. However, since the first support plate 7 and the second support plates 8 are firmly fixed to the vibrating body 6, as described above, the first and second support plates 7 and 8 vibrate stably.

For example, if the vibrating motor 100 is dropped, the first support plate 7 comes into contact with the first damper member 14, or the second support plate 8 comes into contact with the second damper member 15 even if the vibrating body 6 is significantly displaced, preventing collision sound due to the contact between the first support plate 7 and the first cover 2 or the contact between the second support plate 8 and the second cover 3.

At that time, in the stationary state of the vibrating body 6, as illustrated in FIG. 3, the distance L1 between the first support plate 7 and the first base portion 41 of the coil fixing portion 4 in one direction is longer than the distance L2 between the second support plate 8 and the second damper member 15 in one direction. For that reason, even if the vibrating body 6 is greatly displaced toward the other side in one direction, the second support plate 8 comes into contact with the second damper member 15 before the first support plate 7 comes into contact with the first base portion 41, preventing generation of collision sound due to contact between the first support plate 7 and the coil fixing portion 4.

Similarly, in the stationary state of the vibrating body 6, the distance L4 between the second support plate 8 and the second base portion 42 of the coil fixing portion 4 in one direction is longer than the distance L3 between the first support plate 7 and the first damper member 14 in one direction. For that reason, even if the vibrating body 6 is greatly displaced toward one side in one direction, the first support plate 7 comes into contact with the first damper member 14 before the second support plate 8 comes into contact with the second base portion 42, preventing generation of collision sound due to contact between the second support plate 8 and the coil fixing portion 4.

Next, a method for assembling the vibrating motor 100 according to the present embodiment will be described.

The first magnet 61, the second magnet 62, and the pole piece 63 are fixed to the shaft 9, and the shaft 9 is fixed to the vibrating body 6 in advance.

The base portion 31 of the second cover 3 to which the second bearing 13 and the second damper member 15 are fixed is inserted into the casing 1 through the opening at the end on the other side in one direction to bring the protruding portions 32A to 32D of the outer wall 32 of the second cover 3 into contact with an end of the casing 1, so that the second cover 3 is fixed to the casing 1 while being positioned.

The end of the second coil spring 11 on the other side in one direction is housed in the groove 34 of the second cover 3. The protruding portion 81 of the second support plate 8 is fitted radially inside the end of the second coil spring 11 on one side in one direction so that the second support plate 8 is disposed with respect to the second coil spring 11.

The coil fixing portion 4 is inserted into the casing 1 through the opening at an end on one side in one direction to bring the second base portion 42 of the coil fixing portion 4 into contact with the base portion 31 of the second cover 3. At that time, the lead wires 51 and 52 drawn out from the coil 5 fixed to the coil fixing portion 4 extend outward from the interior of the casing 1 through the opening.

The vibrating body 6 to which the shaft 9 is fixed is inserted into the casing 1 through the opening on one side in one direction and is housed in the coil fixing portion 5. At that time, the end of the vibrating body 6 on the other side in one direction is brought into contact with the recessed portion 82 of the second support plate 8.

The first support plate 7 is inserted into the casing 1 through the opening of the end on one side in one direction to bring the recessed portion 72 of the first support plate 7 into contact with the end of the vibrating body 6 on one side in one direction. The first coil spring 10 is located on the first support plate 7 so that the protruding portion 71 of the first support plate 7 is fitted radially inside of the end of the first coil spring 10 on the other side in one direction.

The base portion 21 is inserted into the casing 1 through the opening at the end on one side in one direction so that the end of the first coil spring 10 on one side in one direction is housed in the groove 24 of the first cover 2 to which the first bearing 12 and the first damper member 14 are fixed to bring the protruding portions 22A to 22D of the outer wall 22 into contact with an end of the casing 1. Thus, the first cover 2 is fixed to the casing 1 while being positioned. At that time, the first support plate 7 and the second support plate 8 are pressed against the vibrating body 6 and fixed thereto by the elastic forces due to the compression of the first coil spring 10 and the second coil spring 11. The lead wires 51 and 52 project outward from the outer wall 22 through the cutout portion C2 of the outer wall 22.

Thus, the vibrating motor 100 according to the present embodiment can easily be assembled by assembling the vibrating body 6 in advance. Furthermore, since the first and second support plates 7 and 8 can be firmly fixed respectively only by holding the first support plate 7 with the first coil spring 10 and the vibrating body 6 and holding the second support plate 8 with the second coil spring 11 and the vibrating body 6, the ease-of-assembly is enhanced.

As described above, the vibrating motor 100 according to the present embodiment includes the shaft 9 having the central axis J extending in one direction, the stationary portion S including the coil 5 wound in the circumferential direction of the central axis J, and the vibrating body 6 that is disposed radially outside the shaft 9 and radially inside the coil 5 and that can rotate in one direction with respect to the stationary portion S.

The vibrating motor 100 further includes the first coil spring 10 disposed on one side in one direction between the stationary portion S and the vibrating body 6 and wound in the circumferential direction, the second coil spring 11 disposed on the other side in one direction between the stationary portion S and the vibrating body 6 and wound in the circumferential direction, the first support plate 7 disposed between one side of the vibrating body 6 in one direction and the first coil spring 10, and the second support plate 8 disposed between the other side of the vibrating body 6 in one direction and the second coil spring 11.

The vibrating body 6 includes the first magnet 61 disposed on one side in one direction and the second magnet 62 disposed on the other side in one direction. The first support plate 7 including a magnetic substance is always pressed against the first magnet 61 by an elastic force of the first coil spring 10. The second support plate 8 including a magnetic substance is always pressed against the second magnet 62 by an elastic force of the second coil spring 11.

With such a configuration, the first and second support plates 7 and 8 including a magnetic substance are respectively fixed to the first and second magnets 61 and 62 by the magnetic force and are respectively always pressed against the first and second magnets 61 and 62 by the elastic forces of the first and second coil springs 10 and 11. Thus, the first and second support plates 7 and 8 are firmly fixed to the vibrating body 6, so that the configuration including the vibrating body 6 which is a vibrating member and the first and second support plates 7 and 8 can be made highly stable. This configuration can be achieved by a simple assembly process of merely sandwiching the first and second support plates 7 and 8 between the first and second coil springs 10 and 11 and the first and second magnets 61 and 62, respectively. Furthermore, there is no need to hold the first and second support plates 7 and 8 between weights and magnets for fixation, eliminating the need for weights, thus making a simple configuration in which the number of parts is reduced.

Products in which the vibrating motor 100 according to the present embodiment is to be incorporated are not limited to smartphones, tablet computers, and gamepads. Particularly when the vibrating motor 100 is mounted in a game machine or the like, the size of the vibrating motor 100 can be increased to some extent. Therefore, even with a configuration without a weight, it is easy to ensure sufficient weight by increasing the size of the vibrating body 6.

In the above configuration, the first support plate 7 includes the protruding portion 71 protruding toward one side in one direction and housed radially inside the first coil spring 10, and the second support plate 8 includes the protruding portion 81 protruding toward the other side in one direction and housed radially inside the second coil spring 11.

This allows providing small support plates that are hard to be detached from a coil spring.

In the above configuration, the first support plate 7 and the second support plate 8 have the same shape. For that reason, only one type of support plate is sufficient, so that a simple vibrating motor can be provided. Furthermore, manufacturing cost can be reduced in terms of sharing a mold for producing the support plates and managing the parts of the support plates.

In the above configuration, the stationary portion S includes the first cover 2 housing the first coil spring 10 and disposed at the end on one side in one direction and the second cover 3 housing the second coil spring 11 and disposed at the end on the other side in one direction. The first cover 2 and the second cover 3 have the same shape. This allows a vibrating motor with a simple configuration to be provided, reducing the manufacturing cost.

In the above configuration, the lead wires 51 and 52 drawn out from the coil 5 are drawn to one side in one direction to the outside of the stationary portion S. This eliminates the need for a printed circuit for connecting the lead wires of the coil, leading to reduction in parts and ease of manufacturing process.

In the above configuration, the stationary portion S includes the first cover 2 that houses the first coil spring 10. The sides of the first cover 2 viewed from one side in one direction are 180-degree rotationally symmetric, and the opposing sides respectively include the cutout portions C1 and C2. The lead wires 51 and 52 are passed through the cutout portion C2.

Thus, the lead wires 51 and 52 can be passed through either of the cutout portions C1 and C2 of the sides of the first cover 2 in the assembling process, increasing the flexibility of the orientation in which the first cover 2 is attached, facilitating assembly.

In the above configuration, the first coil spring 10 and the second coil spring 11 overlap with the coil 5 in one direction. This can increase the diameter of the coil springs to prevent the coil springs from buckling.

In the above configuration, the stationary portion S includes the first cover 2 housing the first coil spring 10 and disposed at an end on one side in one direction, the second cover 3 housing the second coil spring 11 and disposed at an end on the other side in one direction, the first damper member 14 fixed to the first cover 2 and facing the first support plate 7 in one direction, and the second damper member 15 fixed to the second cover 3 and facing the second support plate 8 in one direction.

Therefore, even if the vibrating body is abnormally displaced, the support plates come into contact with the damper member, thereby preventing the support plates from coming into contact with the cover to generate collision sound.

In the above configuration, the stationary portion S includes the coil fixing portion 4 that fixes the coil 5, and the vibrating body 6 is housed in the coil fixing portion 4. When the vibrating body S is in the stationary state, the distance L1 between the first support plate 7 and the coil fixing portion 4 in one direction is longer than the distance L2 between the second support plate 8 and the second damper member 15 in one direction. When the vibrating body 6 is in the stationary state, the distance L4 between the second support plate 8 and the coil fixing portion 4 in one direction is longer than the distance L3 between the first support plate 7 and the first damper member 14 in one direction.

Therefore, even if the vibrating body is abnormally displaced, one of the support plates comes into contact with one of the damper members before the other support plate comes into contact with the coil fixing portion, thereby preventing the support plates from coming into contact with the coil fixing portion to generate collision sound.

In the above configuration, the stationary portion S includes the first bearing 12 that supports one side in one direction of the shaft 9 fixed to the vibrating body 6 and the second bearing 12 that supports the other side in one direction of the shaft 9. The first bearing 12 is disposed radially inside the first coil spring 10. The second bearing 13 is disposed radially inside the second coil spring 11. This eliminates the need for disposing the bearings at positions deviated in one direction from the coil springs, decreasing the length of the vibrating motor in one direction.

The first coil spring 10 and the second coil spring 11 are wound in a mutually facing direction in one direction as rotating in the same circumferential direction as viewed from mutually opposite directions in one direction. Therefore, even when a stress in the circumferential direction is exerted on the vibrating body by one of the coil springs, the other coil spring resists, or a stress due to the other coil spring is applied to the vibrating body in the opposite direction. Thus, the stresses cancel each other, preventing noise due to twisting of the vibrating body.

For example, the shaft may be fixed to the covers on both sides in one direction, and the vibrating body may be movable with respect to the shaft. In this case, the bearings are not necessary.

The present disclosure can be used as vibrating motors of various devices.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibrating motor comprising:
a shaft having a central axis extending in one direction;
a stationary portion comprising a coil wound in a circumferential direction of the central axis,
a vibrating body disposed radially outside the shaft and radially inside the coil, the vibrating body being capable of vibrating in one direction with respect to the stationary portion and comprising a first magnet disposed on the first side in one direction and a second magnet disposed on the second side in one direction,
a first coil spring disposed on a first side in one direction between the stationary portion and the vibrating body and wound in the circumferential direction;
a second coil spring disposed on a second side in one direction between the stationary portion and the vibrating body and wound in the circumferential direction;
a first support plate disposed between the first side of the vibrating body in one direction and the first coil spring,
the first support plate comprising a magnetic substance and being always pressed against the first magnet by an elastic force of the first coil spring; and
a second support plate disposed on the second side of the vibrating body in one direction and the second coil spring, the second support plate comprising a magnetic substance and being always pressed against the second magnet by an elastic force of the second coil spring.

2. The vibrating motor according to claim 1,
wherein the first support plate comprises a protruding portion protruding toward the first side in one direction and housed radially inside the first coil spring, and
wherein the second support plate comprises a protruding portion protruding toward the second side in one direction and housed radially inside the second coil spring.

3. The vibrating motor according to claim 2,
wherein the first support plate and the second support plate have a same shape.

4. The vibrating motor according to claim 1,
wherein the first support plate and the second support plate have a same shape.

5. The vibrating motor according to claim 1,
wherein the stationary portion comprises:
a first cover disposed at an end on the first side in one direction, the first cover housing the first coil spring; and
a second cover disposed at an end on the second side in one direction, the second cover housing the second coil spring,
wherein the first cover and the second cover have a same shape.

6. The vibrating motor according to claim 1,
wherein a lead wire from the coil is drawn to the first side in one direction to outside of the stationary portion.

7. The vibrating motor according to claim 6,
wherein the stationary portion comprises a first cover housing the first coil spring,
wherein sides of the first cover viewed from the first side in one direction are 180-degree rotationally symmetric, the sides each comprising a cutout portion, and
wherein the lead wire passes through the cutout portion.

8. The vibrating motor according to claim 7,
wherein the first support plate and the second support plate have a same shape.

9. The vibrating motor according to claim 1,
wherein the first coil spring and the second coil spring overlap with the coil in one direction.

10. The vibrating motor according to claim 9,
wherein the first support plate and the second support plate have a same shape.

11. The vibrating motor claim 10,
wherein the stationary portion comprises:
a first cover disposed at an end on the first side in one direction, the first cover housing the first coil spring; and
a second cover disposed at an end on the second side in one direction, the second cover housing the second coil spring,
wherein the first cover and the second cover have a same shape.

12. The vibrating motor according to claim 1,
wherein the stationary portion comprises:
a first cover disposed at an end on the first side in one direction, the first cover housing the first coil spring;
a second cover disposed at an end on the second side in one direction, the second cover housing the second coil spring;
a first damper member fixed to the first cover and facing the first support plate in one direction; and
a second damper member fixed to the second cover and facing the second support plate in one direction.

13. The vibrating motor according to claim 12,
wherein the stationary portion comprises a coil fixing portion that fixes the coil,
wherein the vibrating body is housed in the coil fixing portion,
wherein, when the vibrating body is in a stationary state, a distance between the first support plate and the coil fixing portion in one direction is longer than a distance between the second support plate and the second damper member in one direction, and
wherein, when the vibrating body is in the stationary state, a distance between the second support plate and the coil fixing portion in one direction is longer than a distance between the first support plate and the first damper member in one direction.

14. The vibrating motor according to claim 13,
wherein the first support plate and the second support plate have a same shape.

15. The vibrating motor according to claim 1,
wherein the stationary portion comprises:
a first bearing that supports the first side in one direction of the shaft fixed to the vibrating body, the first bearing being disposed radially inside the first coil spring, an; and
a second bearing that supports the second side in one direction of the shaft, the second bearing being disposed radially inside the second coil spring.

16. The vibrating motor according to claim 15,
wherein the first support plate and the second support plate have a same shape.

17. The vibrating motor according to claim 16,
wherein the stationary portion comprises:
a first cover disposed at and end on the first side in one direction, the first cover housing the first coil spring;
a second cover disposed at an end on the second side in one direction, the second cover housing the second coil spring,
wherein the first cover and the second cover have a same shape.

18. The vibrating motor according to claim 1,
wherein the first coil spring and the second coil spring are wound in a mutually facing direction in one direction as rotating in a same circumferential direction as viewed from mutually opposite directions in one direction.

19. The vibrating motor according to claim 18,
wherein the first support plate and the second support plate have a same shape.

20. The vibrating motor according to claim 19,
wherein the stationary portion comprises:
a first cover disposed at an end on the first side in one direction, the first cover housing the first coil spring; and
a second cover disposed at an end on the second side in one direction, the second cover housing the second coil spring,
wherein the first cover and the second cover have a same shape.
